(19) United States
(12) Patent Application Publication
(10) Pub. No.: US 2006/0122546 A1
(43) Pub. Date: Jun. 8, 2006

(54) Portable device for the enhancement of circulation

(76) Inventor: Benny Rousso, Rishon LeZion (IL)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/235,649

(22) Filed: Sep. 26, 2005

(30) Foreign Application Priority Data
Sep. 26, 2004 (IL) 164284

(51) Int. Cl. A61H 1/00

(52) U.S. Cl. 601/79

(57) ABSTRACT

A device for enhancing blood and lymph circulation, including, two opposing surfaces for placing on opposite sides of a user's limb, a mechanism for connecting between two or more edges of the two opposing surfaces to effectively encircle the user's limb, and wherein the mechanism is adapted to pull the surfaces closer together and release them intermittently, when deployed on the user's limb.

### RELATED APPLICATIONS

The present application claims priority from Israeli patent application no. 164284 filed Sep. 26, 2004, titled “A PORTABLE DEVICE FOR THE ENHANCEMENT OF CIRCULATION”.

### FIELD OF THE INVENTION

The present invention relates generally to enhancement of blood and lymph flow in a limb. Specifically, the present invention relates to a portable device for enhancing the blood flow in a limb.

### BACKGROUND OF THE INVENTION

Long periods of immobility cause a slow down in blood and lymph flow and may be hazardous to a persons health. Typically when people move, their muscle press on the blood veins and increase the blood flow. In contrast long periods of immobilization lead to stasis (reduced blood flow), which can induce blood clotting (thrombosis) or other problems, for example Deep Vein Thrombosis (DVT) in a limb.

Certain people or people in certain conditions are known to be more prone to the effects of stasis, for example a person undergoing a long period of travel (e.g. by airplane, train), a person working long hours in a set position, people suffering from diabetes. Typically, people in such conditions or incapacitated people are known to suffer from pains in their limbs due to immobility. Additionally, it is believed that 5% of manifested DVT originates from travel as a result of lack of movement.

Increasing blood flow during long periods of immobility, for example by massaging the persons muscles, using warm compresses and/or medication., is know to reduce the risk of blood clotting and to ease pain. Additionally, improving blood circulation has a positive effect on diseased and damaged blood vessels. Existing devices for enhancing circulation are generally large and cumbersome and require trained medical personal to operate them.

The embodiments described in the present application are related to the following applications which are incorporated herein by reference:

Israeli Patent Application no. 160185 filed on Feb. 2, 2004 titled “A PORTABLE DEVICE FOR THE ENHANCEMENT OF CIRCULATION OF BLOOD AND LYMPH FLOW IN A LIMB”.

Israeli Patent Application no. 160214 filed on Feb. 4, 2004 titled “A PORTABLE DEVICE FOR THE ENHANCEMENT OF CIRCULATION OF BLOOD AND LYMPH FLOW IN A LIMB”.

U.S. patent application Ser. No. 10/469,685 titled “A PORTABLE DEVICE FOR THE ENHANCEMENT OF CIRCULATION AND FOR THE PREVENTION OF STASIS RELATED DVT” filed Sep. 3, 2003 and published as 2004/0073146 on Mar. 15, 2004.

### SUMMARY OF THE INVENTION

An aspect of an embodiment of the invention, relates to a portable device for enhancing blood and/or lymph circulation in a users body. The device is provided with two opposite surfaces that are placed against opposite sides of the users limb. The two opposite surfaces of the device are connected together on both their sides with a mechanism that applies a force to pull the surfaces closer together and release them intermittently, while deployed on the user's limb.

In some embodiments of the invention, the device is used for healing damaged and diseased blood vessels. Alternatively or additionally, the device is used for easing pain.

In some embodiments of the invention, the mechanism comprises a linear solenoid to pull the two opposite surfaces together or release them. In some embodiments of the invention, the mechanism comprises multiple linear solenoids.

In an exemplary embodiment of the invention, the surfaces are made from a material, which is comfortable when deployed on a user's limb, for example rubber or cloth.

In some embodiments of the invention, the mechanism functions at a preset duty cycle. Optionally, the duty cycle is user selectable.

In an exemplary embodiment of the invention, the mechanism comprises a power supply, for example a battery. Alternatively, the device is connected to an external power source, for example a main power socket in a house or a car power outlet.

In some embodiments of the invention, said mechanism is activated when connecting a power supply. Optionally, the device comprises an activation switch. In some embodiments of the invention, the device is controlled by an external control. Optionally, the external control is connected by a wire. Alternatively, the external control is connected by a wireless connection, for example RF, Infra-Red or audio. In some embodiments of the invention, the device is controlled by a computer.

In an exemplary embodiment of the invention, the device performs intermittently based on the settings of the mechanism. Alternatively, the device comprises a control circuit to control activation of the mechanism.

There is thus provided according to an exemplary embodiment of the invention, A device for enhancing blood and lymph circulation, including, two opposing surfaces for placing on opposite sides of a user's limb, a mechanism for connecting between two or more edges of the two opposing surfaces to effectively encircle the user's limb, and wherein the mechanism is adapted to pull the surfaces closer together and release them intermittently, when deployed on the user's limb.

Optionally, the mechanism comprises a linear solenoid to pull the surfaces closer together. In some embodiments of the invention, the mechanism functions at a preset duty cycle. Optionally, the mechanism functions at a user selectable duty cycle.

In an exemplary embodiment of the invention, the mechanism comprises a power supply. Optionally, the power supply is a battery. In an exemplary embodiment of the invention, the power supply is internal to the mechanism. Alternatively, the power supply is external to the mechanism.

In an exemplary embodiment of the invention, the mechanism is activated when connecting the power supply. Optionally, the device further comprises an activation switch. In an exemplary embodiment of the invention, the mechanism is activated by a control that is connected to the device by a wire. Optionally, the mechanism is activated by a wireless remote control.

In an exemplary embodiment of the invention, the mechanism is covered so it is not viewable. Optionally, the mechanism is controlled by a computer. In an exemplary embodiment of the invention, the mechanism comprises multiple linear solenoids. Optionally, the mechanism comprises a control circuit to synchronize between the linear solenoids. In an exemplary embodiment of the invention, the surfaces are coated with a soft material. Optionally, the surfaces are arched.

### BRIEF DESCRIPTION OF THE DRAWINGS

The present invention will be understood and appreciated more fully from the following detailed description taken in conjunction with the attached drawings. Identical structures, elements or parts, which appear in more than one figure, are generally labeled with a same or similar number in all the figures in which they appear, wherein:

FIG. 1 is a schematic illustration of a device for circulation enhancement, according to an exemplary embodiment of the invention;

FIG. 2 is a schematic illustration of a device for circulation enhancement in a deployed position, according to an exemplary embodiment of the invention;

FIG. 3 is a schematic illustration of a cross section view of a device for circulation enhancement in a de-energized state according to an exemplary embodiment of the invention;

FIG. 4 is a schematic illustration of a cross section view of a device for circulation enhancement in an energized state according to an exemplary embodiment of the invention;

FIG. 5 is a schematic illustration of a device for circulation enhancement with miniaturized components, according to an exemplary embodiment of the invention;

FIG. 6 is a schematic illustration of a wireless controlled device for circulation enhancement in a deployed position, according to an exemplary embodiment of the invention;

FIG. 7 is a schematic illustration of a hardwired remote controlled device for circulation enhancement in a deployed position, according to an exemplary embodiment of the invention; and

FIG. 8 is a schematic illustration of a wireless controlled device for circulation enhancement in a deployed position with a remote controlling computer, according to an exemplary embodiment of the invention.

### DETAILED DESCRIPTION

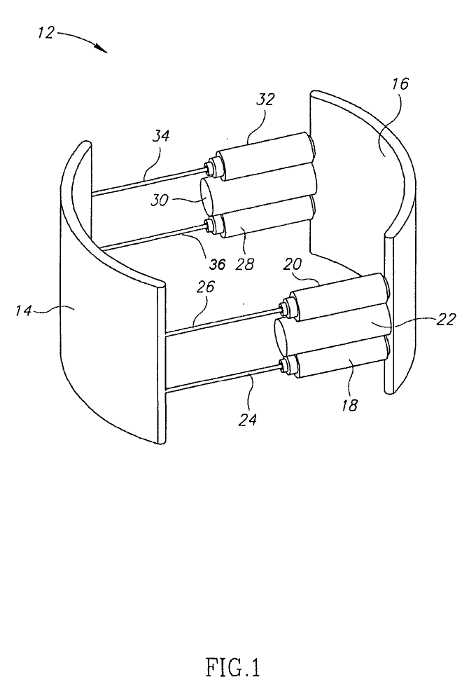

The present invention describes a portable device that is deployed by encircling a user's limb to enhance blood or lymph circulation in the user's body. FIG. 1 is a schematic illustration of a device 12 for circulation enhancement, according to an exemplary embodiment of the invention. In an exemplary embodiment of the invention, device 12 comprises two opposing surfaces 14, 16 for attaching device 12 around a user's limb. In an exemplary embodiment of the invention, surfaces 14 and 16 are arched (e.g. one is concave and one is convex or both are concave) in order to grasp the user's limb securely. In some embodiments of the invention, the surfaces are manufactured from a soft material or a rigid material coated with a soft material to provide a soft contact with the user's limb. In some embodiments of the invention, the surfaces are flexible.

In an exemplary embodiment of the invention, two sides of surface 14 are connected to opposing sides of surface 16 to form a device that encircles the user's limb. Optionally, the connection between the two surfaces comprises a mechanism for pulling surfaces 14 and 16 closer together and releasing them back to their original position. The pulling and releasing action causes surfaces 14 and 16 to press on the user's limb and relax the pressure in order to enhance blood flow. In some embodiments of the invention, both sides comprise a pull release mechanism. Alternatively, only one side comprises a pull release mechanism and the other side is connected with a rigid connection or a flexible or elastic connection.

In an exemplary embodiment of the invention, the mechanism uses linear solenoids (tubular or of other shape) in order to minimize dependency on the use of mechanical parts, which can wear out, for example gears and wheels. A linear solenoid uses electromagnetic energy to move a piston in and out of the linear solenoid. When power is applied to the linear solenoid it is energized and the piston is pulled into the linear solenoid. When the power is turned off the piston moves back out to its original position. It should be noted that some linear solenoids perform the opposite function.

In an exemplary embodiment of the invention, device 12 is built up from four linear solenoids 18, 20, 28, 32 to stabilize device 12. Optionally, each linear solenoid comprises a piston 34, 24, 26, 36, which goes in and out of its matching linear solenoid. In an exemplary embodiment of the invention, one surface (16) is connected to the body of the linear solenoids and one surface (14) is connected to the piston of the linear solenoid. Optionally, the connection can be by an adhesive (e.g. glue, or tape) or by an attachment element, for example a screw, nail or dowel. Alternatively, other attachment methods are used, for example string or snaps.

In an exemplary embodiment of the invention, linear solenoids 18, 20, 28, 32 are powered by a power source, for example a battery. Optionally, multiple power sources are positioned in multiple encasements 22 and 30, in close proximity to linear solenoids 18, 20, 28 and 32. In an exemplary embodiment of the invention, one encasement 22 is positioned between linear solenoids 18 and 20 and one encasement 30 is positioned between linear solenoids 28 and 32. Optionally, the power source in each encasement powers the adjacent linear solenoids. Alternatively, one power source can power all the linear solenoids (18, 20, 28 and 32) or both power sources can power all solenoids.

In some embodiments of the invention, a control circuit is used to accept the power from the battery, synchronize between the linear solenoids and define a duty cycle for linear solenoids 18, 20, 28 and 32. Optionally, the control circuit defines the duration for energizing the linear solenoid and the duration for keeping the linear solenoid in a de-energized state. In some embodiments of the invention, the control circuit is built into the linear solenoid. Alternatively, the control circuit is attached to the linear solenoid. In some embodiments of the invention, one control circuit is used for multiple linear solenoids.

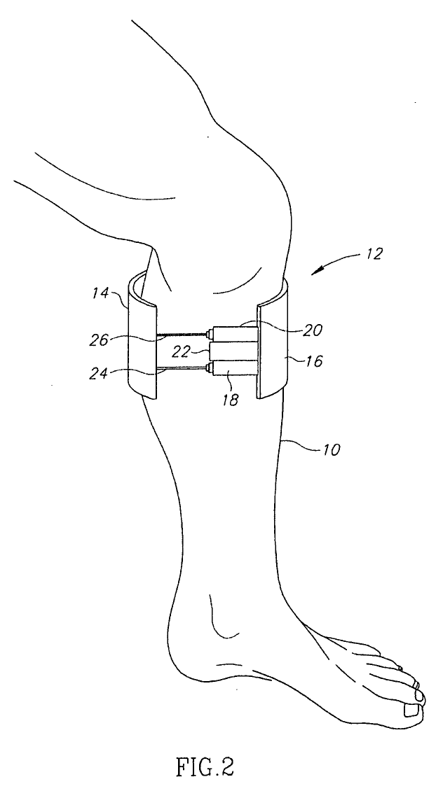

FIG. 2 is a schematic illustration of device 12, in a deployed position, according to an exemplary embodiment of the invention. In some embodiments of the invention, the connection between linear solenoids 18, 20, 28 and 32 and surface 16 is a temporary connection, which can be opened to deploy device 12 on a user's limb 10. Alternatively, the connection between linear solenoids 18, 20, 28 and 32 and surface 16 is a permanent connection and device 12 is deployed by pulling it over user's limb 10. Optionally, device 12 is positioned over the muscle of user's limb 10 to maximize effectiveness of device 12.

In some embodiments of the invention, device 12 is deployed over a user's garments to prevent friction with the user's skin. In some embodiments of the invention, a bandage is placed under device 12 over the user's skin for example in order to protect the user from friction, heat and/or prevent skin or hair from being caught by the moving parts. Optionally, the bandage is disposable for hygienic reasons.

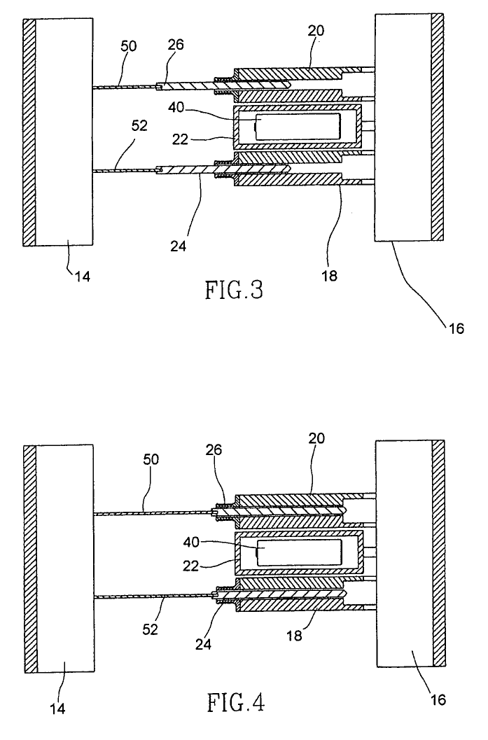

FIG. 3 is a schematic illustration of a cross section view of device 12 for circulation enhancement in a de-energized state according to an exemplary embodiment of the invention and FIG. 4 is a schematic illustration of a cross section view of a device 12 for circulation enhancement in an energized state according to an exemplary embodiment of the invention;

In an exemplary embodiment of the invention, a pull type of linear solenoid is used, for example such as manufactured by Ledex and Dormeyer (www.ledex.com). As shown in FIG. 3 in the de-energized state pistons 26 and 24 are pushed out from the solenoid. In contrast in FIG. 4 in the energized state pistons 26 and 24 are pulled into the solenoid body.

In some embodiments of the invention, pistons 24, 26, 34, 36 are connected directly to surface 14, however in some embodiments an elastic connector 50, 52 is placed between pistons 24, 26, 34, 36 and surface 14 in order to smoothen the motion caused by the force exerted on the user's limb when changing from state to state.

In an exemplary embodiment of the invention, pistons 24, 26, 34, 36 typically extend out of linear solenoids 18, 20, 28, 30 by 1 to 5 cm, however some pistons may extend out by more or less than these values.

In some embodiments of the invention, the linear solenoids 18, 20, 28, 30 are activated with a typical duty cycle ranging from 10% to 100%. Optionally, in the case of a 10% duty cycle the piston is pulled in to the solenoid, exerting pressure on the user's limb, 10% of the time. In the case of a 100% duty cycle device 12 exerts continuous pressure on the user's limb until it is shut off.

In some cases the duty cycle is selectable by the user. Alternatively, the duty cycle is preset when manufacturing device 12.

In some embodiments of the invention, the solenoid is activated for 1-5 seconds every 1-5 minutes in order to maximize efficiency in matching human needs.

In an exemplary embodiment of the invention, in the cross sectional views shown in FIG. 3 and FIG. 4 a battery 40 is shown in encasement 22, serving as the power source as mentioned above. In some embodiments of the invention, device 12 is activated by inserting battery 40 into encasement 22. Alternatively, device 12 is activated by a switch or a remote signal as described below.

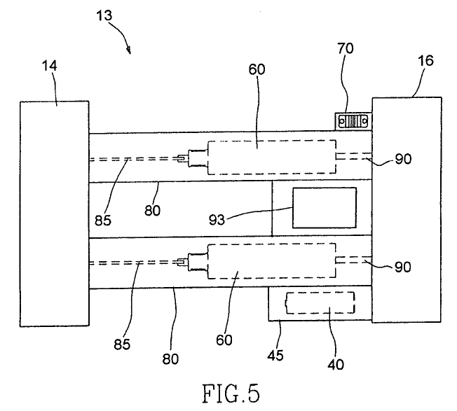

In some embodiments of the invention, it is desirable to minimize the size of the elements connecting between surface 14 and surface 16, to reduce annoyance to the user. Optionally, connecting between them with a simple elastic band would be desirable. FIG. 5 is a schematic illustration of a device for circulation enhancement with miniaturized components, according to an exemplary embodiment of the invention. In an exemplary embodiment of the invention, surfaces 14 and 16 are connected by one wide elastic band or two less wide elastic bands 80. Optionally, the band or bands 80 are comprised from an elastic fabric. In some embodiments of the invention, the bands 80 form a hollow tube which covers elements required for the functionality of device 12. In some embodiments of the invention, bands 80 comprise non-elastic fabric covering over the elements required for the functionality of device 12, to make them un-viewable.

Optionally, a small sized linear solenoid 60 is inserted into bands 80. In an exemplary embodiment of the invention, one side of linear solenoid 60 is attached by a string 90 to surface 16 and the other side is attached by a string or elastic band 85 to surface 14.

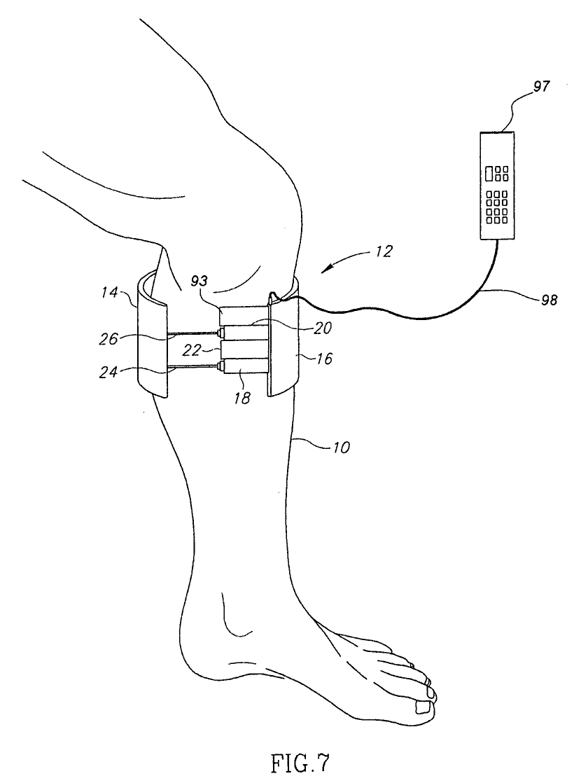

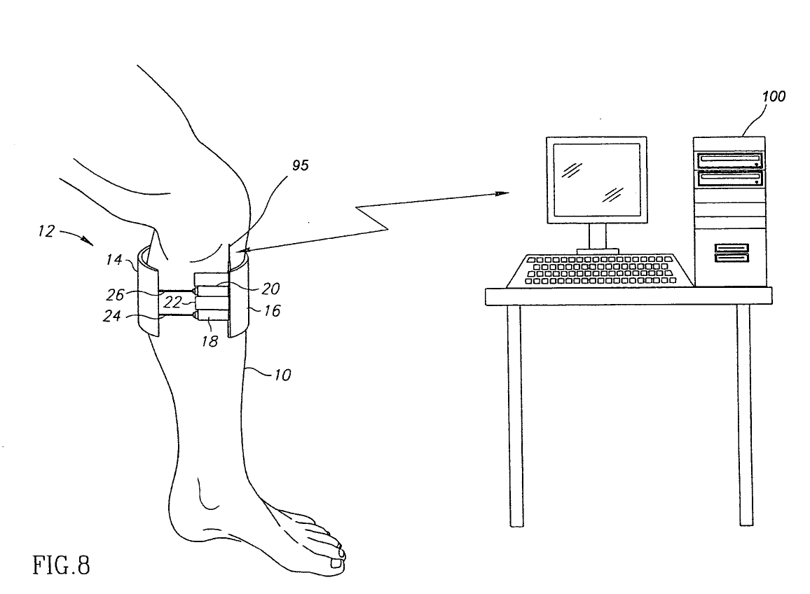

In an exemplary embodiment of the invention, device 12 additionally comprises an activation switch 70 to start and stop intermittent motion of linear solenoid 60. Optionally, the power source (e.g. battery 40) in some embodiments is enveloped similar to linear solenoid 60, for example inserted into bands 80 or in a separate enveloping fabric compartment 45 as shown in FIG. 5. In some embodiments of the invention, battery 40 is a standard 1.5V cylindrical battery. Alternatively, battery 40 is a flat circular battery or a battery of any other shape. In some embodiments of the invention, the battery is external to device 12 and supplies power through a cable (e.g. cable 98 as shown in FIG. 7). Optionally, the external power source is a car power supply (e.g. lighter) or a transformer connected to a standard main power source.

In some embodiments of the invention, device 12 comprises other elements, for example a control circuit 93 to control activation rate or other parameters of device 12.

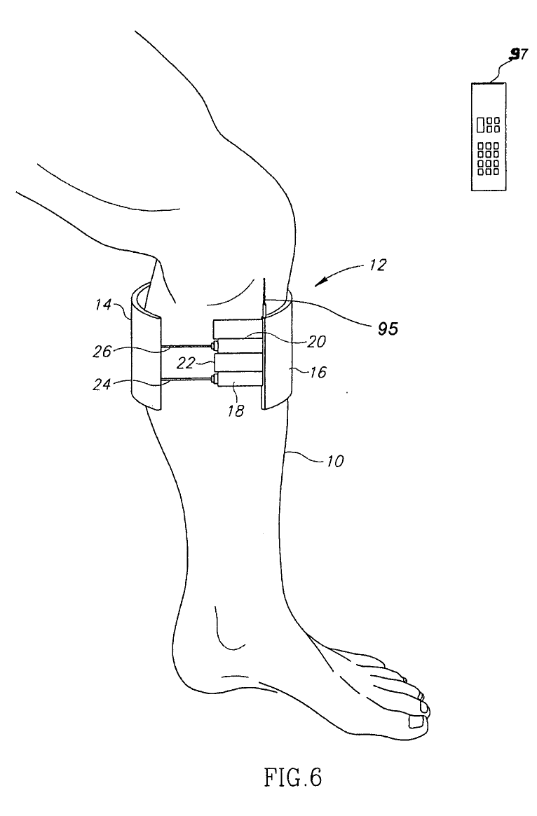

In some embodiments of the invention, device 12 is activated remotely in order enhance the ease of use of device 12 by the user, for example by saving the user the need to bend over to activate device 12. FIG. 6 is a schematic illustration of a wireless controlled device for circulation enhancement in a deployed position, according to an exemplary embodiment of the invention. Optionally, a user of device 12 can activate and deactivate the device using a remote controller 97. In some embodiments of the invention, remote controller 97 controls other parameters such as the intermittent action rate. In some embodiments of the invention, remote controller 97 transmits instructions to device 12 using RF. Optionally, device 12 comprises an antenna 95 to receive the transmissions. In some embodiments of the invention, remote controller 97 transmits to device 12 using audio signals or infrared signals instead of RF signals in order to reduce interference to other devices and susceptibility to transmissions from other devices.

FIG. 7 is a schematic illustration of a hardwired remote controlled device for circulation enhancement in a deployed position, according to an exemplary embodiment of the invention. Optionally, remote controller 97 is connected by a wire 98 to device 12, in order to prevent interference to other devices. In an exemplary embodiment of the invention, a user can hold remote controller 97 in his hand and control device 12 without looking or touching device 12. Alternatively or additionally, device 12 can be controlled by another person, for example a nurse or caretaker.

FIG. 8 is a schematic illustration of a wireless controlled device for circulation enhancement in a deployed position with a remote controlling computer 100, according to an exemplary embodiment of the invention. In some embodiments of the invention, device 12 can be controlled by commands given by a computer, for example setting the duty cycle used by device 12. Optionally, device 12 is activated and deactivated at scheduled times and/or activated or deactivated by a remote computer, for example from a station over a local network or over the Internet.

In some embodiments of the invention, other pull release mechanisms are used, for example a small motor, which pulls the sides together and releases them. In some embodiments of the invention the mechanism may be based on electromagnetic forces. Alternatively or additionally, the mechanism may be based on mechanical means such as a spring. In some embodiments of the invention, the mechanism may comprise springs to oppose compression forces so that in the released state device 12 is in a more relaxed position.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention.

Section headings are provided for assistance in navigation and should not be considered as necessarily limiting the contents of the section.

It will be appreciated by persons skilled in the art that the present invention is not limited to what has been particularly shown and described hereinabove. Rather the scope of the present invention is defined only by the claims, which follow.

1. A device for enhancing blood and lymph circulation, comprising:
two opposing surfaces for placing on opposite sides of a user's limb;
a mechanism for connecting between two or more edges of the two opposing surfaces to effectively encircle the user's limb; and
wherein said mechanism is adapted to pull the surfaces closer together and release them intermittently, when deployed on the user's limb.

2. A device according to claim 1, wherein said mechanism comprises a linear solenoid to pull the surfaces closer together.

3. A device according to claim 1, wherein said mechanism functions at a preset duty cycle.

4. A device according to claim 1, wherein said mechanism functions at a user selectable duty cycle.

5. A device according to claim 1, wherein said mechanism comprises a power supply.

6. A device according to claim 4, wherein said power supply is a battery.

7. A device according to claim 4, wherein said power supply is internal to said mechanism.

8. A device according to claim 4, wherein said power supply is external to said mechanism.

9. A device according to claim 4, wherein said mechanism is activated when connecting said power supply.

10. A device according to claim 1, further comprising an activation switch.

11. A device according to claim 1, wherein said mechanism is activated by a control that is connected to said device by a wire.

12. A device according to claim 1, wherein said mechanism is activated by a wireless remote control.

13. A device according to claim 1, wherein said mechanism is covered so that it is not viewable.

14. A device according to claim 1, wherein said mechanism is controlled by a computer.

15. A device according to claim 1, wherein said mechanism comprises multiple linear solenoids.

16. A device according to claim 14, wherein said mechanism comprises a control circuit to synchronize between the linear solenoids.

17. A device according to claim 1, wherein said surfaces are coated with a soft material.

18. A device according to claim 1, wherein said surfaces are arched.
